(19) United States
(12) Patent Application Publication
(10) Pub. No.: US 2011/0178252 A1
(43) Pub. Date: Jul. 21, 2011

(54) PHENOL NOVOLAC RESIN, PHENOL NOVOLAC EPOXY RESIN AND EPOXY RESIN COMPOSITION

(75) Inventors: Ick Kyung Sung, Incheon (KR); Sang Min Llee, Seoul (KR); Sang Youb Seong, Gyeonggi-do (KR); Jung Ha Chung, Gyeonggi-do (KR)

(73) Assignee: KOLON INDUSTRIES, INC., Gyeonggi-do (KR)

(21) Appl. No.: 13/059,867

(22) PCT Filed: Aug. 31, 2009
(86) PCT No.: PCT/KR2009/004885

§ 371 Date: Apr. 11, 2011

(30) Foreign Application Priority Data
Sep. 1, 2008 (KR) 10-2008-0085644

(51) Int. Cl. C08L 63/04; C08G 59/24; C08G 8/10

(52) U.S. Cl. 525/482; 528/107; 528/153; 525/480

(57) ABSTRACT

Disclosed herein are a phenol novolac resin which is used as a raw material for thermosetting resin, a phenol novolac epoxy resin which is obtained therefrom, an epoxy resin composition which utilizes the phenol novolac resin as a curing agent or contains the phenol novolac epoxy resin as a base resin.

### TECHNICAL FIELD

The present invention relates to a phenol novolac resin which is used as a raw material for thermosetting resin, a phenol novolac epoxy resin which is obtained therefrom, and an epoxy resin composition which utilizes the phenol novolac resin as a curing agent or contains the phenol novolac epoxy resin as a base resin.

### BACKGROUND ART

Typically, phenol novolac resins which are used as raw materials for thermosetting resins and the like are obtained by the reaction of phenolic compounds with aldehydes.

Examples of phenol novolac resins known heretofore include phenolic compounds such as phenol, cresol, xylenol, butylmethylphenol, phenylphenol, biphenol, naphthol, bisphenol A and bisphenol F.

Examples of aldehydes include aliphatic aldehydes such as formaldehyde, acetaldehyde, butyraldehyde or glyoxal; unsaturated aliphatic aldehydes such as acrolein; aromatic aldehydes such as benzaldehyde or hydroxybenzaldehyde; and unsaturated aromatic aldehydes such as cinnamaldehyde.

The reaction of such phenolic compounds with aldehydes can yield phenol novolac resins.

Phenol novolac resins can be used in various fields, and there is a continued demand for phenol novolac resins, because they are excellent in heat resistance, chemical resistance, dimensional stability and the like and have balanced properties and cost-effectiveness. Due to such advantages, phenol novolac resins are used in a wide range of applications, including molding materials for electrical/electronic parts or mechanical parts, laminated products such as sheets, rods or tubes, and convenience goods.

Meanwhile, phenol novolac resins are useful as intermediates for epoxy resins. Among them, as bisphenol-type epoxy resins known in the art, bisphenol-A-based epoxy resins and bisphenol-F-based epoxy resins are commercially prepared and widely used in various fields.

However, these two types of resins have low thermal stability at high temperatures, and for this reason, the use thereof in high-performance structural materials has been limited. In this respect, the development of a resin having new physical properties is urgently needed, and attention is being paid to improving the physical properties of a resin by introducing other functional groups into the main chain.

Epoxy resins which are compounds having one or more epoxy groups in the molecule were developed as adhesives having phenomenal performance during World War II and have recently been widely used in castings, molded articles, paints, etc. Such epoxy resins are prepared by the ring opening of the epoxy groups, and an industrial method which is currently used to prepare epoxy resins is the condensation of bisphenol A and epichlorohydrin. The reaction of epichlorohydrin with polyhydric phenol is carried out at a temperature of 60-120° C. in the presence of sodium hydroxide and a catalyst, thus preparing various resins having an average molecular weight of 350-7,000 depending on the amounts of reactants used and reaction conditions. Epoxy resins are classified into various types, and major examples thereof include bisphenol-A epichlorohydrin resin, epoxy novolac resin, alicyclic epoxy resin, brominated epoxy resin, multifunctional epoxy resin, etc.

Also, epoxy resins are cured by various curing agents to form a network structure. The choice of the curing agent is a factor determining the properties of the final product, and thus is as important as the choice of the resin base. Bisphenol-A-type epoxy resin is a typical condensation polymer which is produced by condensation of bisphenol A and epichlorohydrin in the presence of an alkali. Although epoxy resins have excellent properties, including excellent thermal resistance and electrical insulation properties, they are seldom used alone and are used together with a curing agent. Also, because epoxy resins are very compatible with inorganic materials, they are, in most cases, used in combination with filler or reinforcing materials such as silica and titanium oxide. Because the physical properties of epoxy resins vary greatly depending on the choice of these curing agents and filler or reinforcing materials, studies on the use of epoxy resins in a wide range of applications are being conducted.

Epoxy resins are being used in paints having adhesive properties, electrical/electronic parts such as printed circuit boards or IC encapsulation materials, adhesives and the like. Also, epoxy resins are used in electrical equipment such as computer equipment or VCRs.

The properties of epoxy resins can vary depending on the choice of the curing agent as described above, and curing agents used with epoxy resins include amines, acidic anhydrides, etc.

Meanwhile, the miniaturization of electronic machines and equipment is accomplished by the use of printed circuit boards having improved heat resistance, moisture resistance and measling resistance.

It is known in the art that the heat resistance of a cured epoxy resin composition can be improved by incorporating a polyfunctional epoxy resin, such as phenol novolac-type epoxy resin, cresol novolac-type epoxy resin, bisphenol-A-type epoxy resin or a triglycidyl ether of p-aminophenol, into an epoxy resin.

The known epoxy resin composition having improved heat resistance is a reaction product of a polyhydric phenolic compound, a bisphenol-A-type epoxy resin and a polyfunctional epoxy resin selected from the above-mentioned polyfunctional epoxy resins.

### DISCLOSURE

### Technical Problem

In one aspect of the present invention, there is provided a novel phenol novolac resin.

In another aspect of the present invention, there is provided a novel bisphenol-B novolac epoxy resin.

In still another aspect of the present invention, there is provided an epoxy resin composition comprising a novel phenol novolac epoxy resin.

In yet another aspect of the present invention, there is provided an epoxy resin composition comprising a novel bisphenol-B novolac epoxy resin as a base resin.

### Technical Solution

In one aspect of the present invention, there is provided a phenol novolac resin which contains a repeating unit represented by the following formula 1 in the molecule and has a softening point between 50° C. and 150° C.

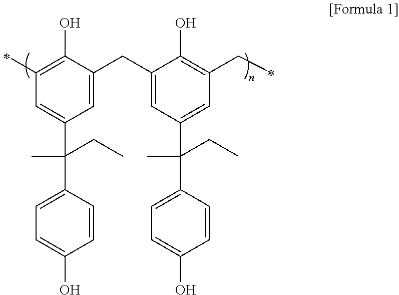

The phenol novolac resin of the present invention may have a weight-average molecular weight of 500 to 5,000.

In another aspect of the present invention, there is provided a phenol novolac epoxy resin which contains a repeating unit represented by the following formula 2 in the main chain.

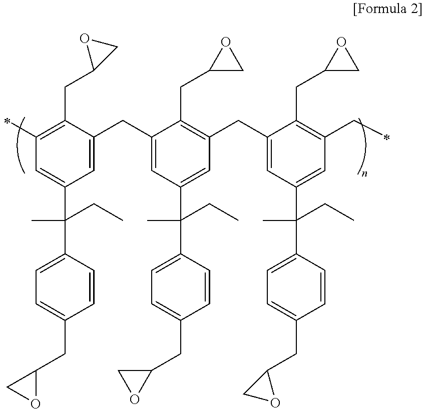

The phenol novolac epoxy resin of the present invention may have an epoxy equivalent between 150 and 400 and a softening point between 50° C. and 150° C.

Also, the phenol novolac epoxy resin may have a UV absorbance of not less than 1.1 at 278 nm.

In still another aspect of the present invention, there is provided an epoxy resin composition comprising: an epoxy resin; and a curing agent including said phenol novolac resin.

Herein, the epoxy resin may include the phenol novolac epoxy resin which contains the repeating unit represented by formula 2 in the main chain.

In yet another aspect of the present invention, there is an epoxy resin composition comprising: an epoxy resin including the phenol novolac epoxy resin; and a curing agent.

Hereinafter, the present invention will be described in further detail.

### (A) Phenol Novolac Resin

Generally, a phenol novolac resin is obtained by condensation of phenol with an aldehyde and/or ketone in the presence of an acid catalyst.

The phenol novolac resin of the present invention is a bisphenol-B novolac resin.

This bisphenol-B novolac resin can also be obtained by condensation of bisphenol B with an aldehyde and/or ketone in the presence of an acid catalyst.

Examples of the aldehyde which can be used in the present invention include formaldehyde, paraformaldehyde, trioxane, acetaldehyde, propionaldehyde, butyraldehyde, trimethylacetaldehyde, acrolein, crotonaldehyde, cyclohexanecarbaldehyde, furfural, furylacrolein, benzaldehyde, terephthalaldehyde, phenylacetaldehyde, α-phenylpropylaldehyde, β-phenylpropylaldehyde, o-hydroxybenzaldehyde, m-hydroxybenzaldehyde, p-hydroxybenzaldehyde, o-methylbenzaldehyde, m-methylbenzaldehyde, p-methylbenzaldehyde, o-chlorobenzaldehyde, m-chlorobenzaldehyde, p-chlorobenzaldehyde, and cinnamaldehyde. These aldehydes may be used alone or in combination. Among these aldehydes, formaldehyde is preferable in terms of easy availability. Particularly, hydroxybenzaldehyde and formaldehyde may be used in combination in order to improve heat resistance.

Examples of the ketone which can be used in the present invention include acetone, methylethylketone, diethylketone, and diphenylketone. These ketones may be used alone or in combination.

The content of aldehyde and/or ketone in the bisphenol-B novolac resin may be 0.5-0.99 moles per mole of bisphenol-B, but may vary depending on the desired molecular weight of the phenol novolac resin.

An acid catalyst which can be used in the condensation of bisphenol-B with aldehyde and/or ketone is not particularly limited, and examples thereof include hydrochloric acid, sulfuric acid, formic acid, oxalic acid, and paratoluenesulfonic acid.

The catalyst may generally be used in an amount of 0.0001-0.1 moles per mole of bisphenol-B.

The condensation reaction of bisphenol-B with aldehyde and/or ketone can be carried out at a temperature of 80 to 130° C. in the presence of a catalyst. If the reaction temperature is lower than 80° C., the reaction rate will be decreased, and if the temperature is higher than 130° C., the reaction rate will be excessively increased. The reaction temperature may preferably range from 90 to 120° C. The phenol novolac resin thus obtained has a softening point ranging from 100 to 150° C. and a weight-average molecular weight ranging from 500 to 5,000 and contains a repeating unit represented by the following formula 1:

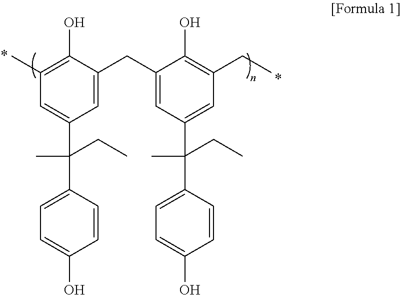

### (B) Bisphenol-B Novolac Epoxy Resin

The bisphenol novolac epoxy resin according to one aspect of the present invention can be obtained by glycidylating the bisphenol-B novolac resin described in the above section (A) with epichlorohydrin. Specifically, the bisphenol-A novolac resin is allowed to react with epichlorohydrin in the presence of a base catalyst, thus preparing an epoxy resin containing a bisphenol-B residue in the main chain. Herein, the bisphenol-B novolac resin, the epichlorohydrin and the catalyst are preferably used at a molar ratio of 1:3.5-5.5:0.9-1.5.

Also, the glycidylation reaction is preferably carried out at a temperature ranging from 55 to 70° C. In this temperature region, the production of byproducts can be minimized, the loss of epichlorohydrin can be minimized, and the molecular weight of the epoxy resin can be suitably controlled.

As the catalyst, NaOH is preferably used. NaOH serving as the catalyst is used at a concentration ranging from 30 to 60%. At this concentration range, the discoloration of the prepared resin and the production of byproducts can be minimized, and a suitable reaction rate is obtained.

The reaction time may be a total of 2-6 hours.

The obtained bispenol-B novolac epoxy resin contains a repeating unit represented by the following formula 2 in the main chain and may have a weight-average molecular weight of 1000-8000:

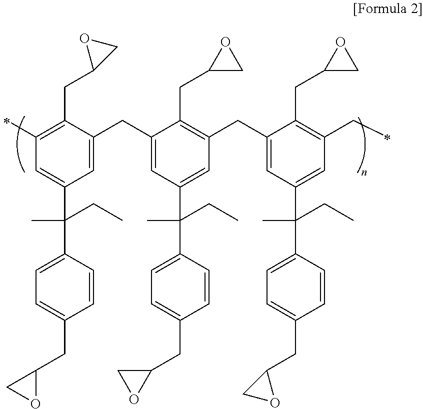

Also, the epoxy equivalent of the bisphenol-B novolac epoxy resin is preferably 100-400, and the softening point thereof is preferably between 50° C. and 150° C. in view of viscosity.

In addition, the obtained polyfunctional bisphenol-B novolac epoxy resin has a UV absorbance of not less than 1.1% at 278 nm in view of each measurement of the concentration of bisphenol-B.

Meanwhile, in order to dissolve the reactants during the preparation of the resin and to adjust the solid content and viscosity of the resin component solution after completion of the reaction, an organic solvent may be used. Examples of a solvent suitable for such purposes include ketones such as methyl ethyl ketone, cyclopentanone and cyclohexanone, ethers such as tetrahydrofuran, 1,3-dioxolane and 1.4-dioxane, glycol ethers such as dipropyleneglycol dimethyl ether and dipropyleneglycol diethyl ether, esters such as ethyl acetate, butyl acetate, butylcellosolve acetate and carbitol acetate, aromatic hydrocarbons such as toluene, xylene and tetramethylbenzene, aliphatic hydrocarbons such as octane and decane, and petroleum solvents such as petroleum ether, petroleum naphtha, hydrogenated petroleum naphtha and solvent naphtha. These solvents may be used alone or in a mixture of two or more of them depending on the utilization and solubility of a specific reactant.

### (C) Epoxy Resin Composition

The epoxy resin composition which is generally used to manufacture copper-clad laminates for printed circuit boards comprises an epoxy resin and a curing agent and may additionally comprise a curing accelerator and a solvent.

Examples of the epoxy resin include epoxy resins having one or more epoxy groups in the single molecule, for example, glycidyl ether-type epoxy resins, such as bisphenol A-type epoxy resins, phenol novolak-type epoxy resins, cresol novolak-type epoxy resins, glycidyl ester-type epoxy resins, glycidyl amine-type epoxy resins, linear aliphatic epoxy resins, alicyclic epoxy resins, heterocyclic epoxy resins, halogenated epoxy resins, and other polyfunctional epoxy resins. Among them, the bisphenol-B novolac epoxy resin may be used or contained as the epoxy resin in the epoxy resin composition of the present invention.

In this case, the bisphenol-B novolac epoxy resin is preferably used in an amount of at least 20 wt % based on the total weight of epoxy resin in terms of improvements in adhesive strength, heat resistance and the like.

As the curing agent, one selected from among polyamine, dicyandiamide, acid anhydride and phenol novolac resin. Herein, the bisphenol-B novolac resin may be contained as the curing agent. If the bisphenol-B novolac resin is contained as the curing agent in the epoxy resin composition, it may be used in an amount of at least 10 wt % based on the total amount of the curing agent.

The equivalent ratio of the epoxy resin and the curing agent in the epoxy resin composition is preferably about 1:0.8-1.2.

Meanwhile, the epoxy resin composition may additionally comprise a curing accelerator. Examples of the curing accelerator include, but are not limited to, tertiary phosphine compounds such as triphenyl phosphine.

Examples of a solvent which is used in the epoxy resin composition include, but are not limited to, acetone, methyl ethyl ketone, toluene, xylene, methyl isobutyl ketone, ethyl acetate, ethylene glycol monomethyl ether, N,N-dimethylformamide, N,N-dimethylacetamide, methanol and ethanol. These solvents may be used alone or in combination.

If necessary, the epoxy resin composition according to one embodiment of the present invention may comprise additional additives such as a flame retardant or a filler.

This epoxy resin composition may be used to manufacture copper-clad epoxy laminates. A method for manufacturing the copper-clad epoxy laminates can be carried out according to any method known in the art. For example, a copper-clad epoxy laminate can be manufactured by impregnating a glass clad with the epoxy resin composition, drying and heating the impregnated glass clad to prepare a prepreg, placing a copper foil on one or both sides of the single pregpreg or a layered structure consisting of a plurality of the prepregs, and heating the assembly under pressure according to a conventional method.

### Advantageous Effects

According to one aspect of the present invention, there can be provided a novel phenol novolac resin which can be used as a substitute for bisphenol-A novolac resin and the like. Such a phenol novolac resin can be used as an intermediate to prepare a phenol novolac epoxy resin or as a curing agent to prepare an epoxy resin composition. Also, the phenol novolac epoxy resin can be used as a base resin to prepare an epoxy resin composition. The epoxy resin compositions can be used to manufacture copper-clad laminates.

### DESCRIPTION OF DRAWINGS

The above and other objects, features and other advantages of the present invention will be more clearly understood from the following detailed description taken in conjunction with the accompanying drawings, in which:

FIG. 1 is a graphic diagram showing the results of FT-IR analysis for a phenol novolac epoxy resin obtained in Example 6; and

FIG. 2 shows the results obtained by measuring the UV absorbance of a phenol novolac epoxy resin obtained in Example 6.

### MODE FOR INVENTION

A better understanding of the present invention may be obtained through the following examples which are set forth to illustrate, but are not to be construed as the limit of the present invention.

In the following examples, the measurement of molecular weight was carried out in the following conditions:

1. Waters GPC system

Pump: 515 HPLC pump

717 Autosampler

2996 RI Detector

2. Flow: 1.0 ml/min

### 3. Oven Temp: 35° C.

### 4. Run Time: 45 min

### 5. Injection Volume: 100 μl

6. Columns: a total of 4 columns (HR 0.5, HR 1, HR 2, and HR3)

### 7. Mobile Phase: THF

### 8. Standard Calibration (Polystyrene/Mw)

### A: 31,400/9,000/2,980/486

### B: 18,200/6,480/1,260/94

### C: 13,900/3,950/890

Also, the measurement of softening point was carried out at a rate of 2° C./min using a FP900 thermo system equipped with a FP 83HT dropping point cell (Mettler-Toledo Inc.).

The measurement of epoxy equivalent was carried out in the following manner. A suitable sample of a sample was collected in an Erlenmeyer flask and completely dissolved by adding 20 ml of 1,4-dioxane thereto. 5 ml of HCl was added to the solution. After 30 minutes, a Cresol Red indicator was added thereto, and titration with NaOH solution was conducted. At this time, the point at which the indicator changed from pink to yellow and finally to violet was considered as the end point. Separately, a blank test was carried out without using the sample.

The measurement of free chlorine (CI) was carried out in the following manner. 0.1 mg of a sample was collected in a 200-ml Erlenmeyer flask and dissolved by the addition of 25 ml of dioxane. Then, 25 ml of 0.1N KOH solution was added thereto and the mixture was allowed to react in a water bath for 30 minutes. After the reaction mixture was cooled to room temperature, 3 ml of acetic acid was added thereto, and the solution was titrated with 0.01N AgNO₃ aqueous solution.

In addition, the measurement of UV absorbance was carried out in the following manner. 0.01 g of a resin was metered into a 100-ml flask with a stopper and dissolved by the addition of 100 ml of THF. The absorbance in the wavelength range from 250 nm to 500 nm was measured using a Varian spectrophotometer Cary 100. Meanwhile, the measurement of the absorbance of a cured film was carried out in the same manner as the measurement of the absorbance of the resin.

### Example 1

### Preparation of Bisphenol-B Novolac Resin

100 g of bisphenol-B, 8 g (corresponding to 0.6 moles per mole of bisphenol-B) of 89% formalin and 0.035 g (corresponding to 0.35 parts by weight based on 100 parts by weight of bisphenol-B) of diethyl sulfate were added to a 2-L-multi-necked flask. Then, the content of the flask was heated at 90° C. under a nitrogen blanket. After complete dissolution of the content was confirmed, the temperature was elevated to 120° C., and the content was additionally heated at that temperature for 3 hours. Then, the reaction material was vacuum-distilled at 165-176° C. at 16.5-30 inches of mercury vacuum to recover 97 g of product and 11 g of distillate.

The bisphenol-B-formaldehyde condensate prepared in this Example had a weight-average molecular weight of 1905 and a softening point of 131° C., and the content of unreacted bisphenol-B was 5.4 wt % based on the total weight of the product.

### Example 2

### Preparation of Bisphenol-B Novolac Resin

100 g of bisphenol-B, 22 g (corresponding to 0.73 moles per mole of bisphenol-B) of 40% formalin and 0.035 g (corresponding to 0.35 parts by weight based on 100 parts by weight of bisphenol-B) of diethyl sulfate were added to a 2-L-multi-necked flask. Then, the content of the flask was heated at 90° C. under a nitrogen blanket. After complete dissolution of the content was confirmed, the temperature was elevated to 120° C., and the content was additionally heated at that temperature for 3 hours. Then, the reaction material was vacuum-distilled at 165-176° C. at 16.5-30 inches of mercury vacuum to recover 101 g of product and 21 g of distillate.

The bisphenol-B-formaldehyde condensate prepared in this Example had a weight-average molecular weight of 1750 and a softening point of 125° C., and the content of unreacted bisphenol-B was 7.2 wt % based on the total weight of the product.

### Example 3

### Preparation of Bisphenol-B Novolac Resin

100 g of bisphenol-B, 20 g (corresponding to 0.65 moles per mole of bisphenol-B) of 40% formalin and 0.035 g (corresponding to 0.35 parts by weight based on 100 parts by weight of bisphenol-B) of oxalic acid were added to a 2-L-multi-necked flask. Then, the content of the flask was heated at 90° C. under a nitrogen blanket. After complete dissolution of the content was confirmed, the temperature was elevated to 120° C., and the content was additionally heated at that temperature for 3 hours. Then, the reaction material was vacuum-distilled at 165-176° C. at 16.5-30 inches of mercury vacuum to recover 98 g of product and 29 g of distillate.

The bisphenol-B-formaldehyde condensate prepared in this Example had a weight-average molecular weight of 1630 and a softening point of 124° C., and the content of unreacted bisphenol-B was 6.7 wt % based on the total weight of the product.

Meanwhile, the reaction products of the portion was heated at 176° C. as well as that which was not so heated can be flaked by conventional means used for flaking a novolac resin.

### Example 4

### Preparation of Bisphenol-B Novolac Epoxy Resin

A one-liter flask was charged with 30 g of the flaked reaction product prepared in Example 1, 5.2 g of KOH, 15 g of epichlorohydrin and 40 g of reaction solvent MIBK to form a reaction mixture. The reaction mixture was heated to 60° C. and allowed to react for 1 hour. Then, 40 g of a 20% solution of sodium hydroxide in water was added thereto in three portions over a period of 3 hours while maintaining a temperature of 60±5° C. Then, the reaction mixture was heated to 150° C. to discharge the condensed water. Then, 45 g of water and 30 g of MIBK were added and the reaction mixture was held at 80° C. for 1 hour and then transferred to a reparatory funnel. The lower aqueous layer was removed and the upper organic layer was washed twice, neutralized with phosphoric acid, filtered and then vacuum-distilled to remove excess epichlorohydrin and the solvent and water and to obtain about 27 g of dark resin, an epoxidized product. The epoxy equivalent, softening point, free Cl content and molecular weight of the obtained epoxy resin are summarized in Table 1 below.

### Example 5

### Preparation of Bisphenol-B Novolac Epoxy Resin

A one-liter flask was charged with 30 g of the flaked reaction product prepared in Example 2, 5.2 g of KOH, 15 g of epichlorohydrin and 40 g of reaction solvent MIBK to form a reaction mixture. The reaction mixture was heated to 60° C. and allowed to react for 1 hour. Then, 40 g of a 20% solution of sodium hydroxide in water was added thereto in three portions over a period of 3 hours while maintaining a temperature of 60±5° C. Then, the reaction mixture was heated to 150° C. to discharge the condensed water. Then, 45 g of water and 30 g of MIBK were added and the reaction mixture was held at 80° C. for 1 hour and then transferred to a separatory funnel. The lower aqueous layer was removed and the upper organic layer was washed twice, neutralized with phosphoric acid, filtered and then vacuum-distilled to remove excess epichlorohydrin and the solvent and water and to obtain about 27 g of dark resin, an epoxidized product. The epoxy equivalent, softening point, free Cl content and molecular weight of the obtained epoxy resin are summarized in Table 1 below.

### Example 6

### Preparation of Bisphenol-B Novolac Epoxy Resin

A one-liter flask was charged with 30 g of the flaked reaction product prepared in Example 3, 5.2 g of KOH, 15 g of epichlorohydrin and 40 g of reaction solvent MIBK to form a reaction mixture. The reaction mixture was heated to 60° C. and allowed to react for 1 hour. Then, 40 g of a 20% solution of sodium hydroxide in water was added thereto in three portions over a period of 3 hours while maintaining a temperature of 60±5° C. Then, the reaction mixture was heated to 150° C. to discharge the condensed water. Then, 45 g of water and 60 g of MIBK were added and the reaction mixture was held at 80° C. for 1 hour and then transferred to a separatory funnel. The lower aqueous layer was removed and the upper organic layer was washed twice, neutralized with phosphoric acid, filtered and then vacuum-distilled to remove excess epichlorohydrin and the solvent and water and to obtain about 37 g of dark resin, an epoxidized product. The epoxy equivalent, softening point, free Cl content and molecular weight of the epoxy resins obtained in Examples 4 to 6 are summarized in Table 1 below.

TABLE 1
*120

| | Example 4 | Example 5 | Example 6 |
|---|---|---|---|
| Softening point (° C.) | 64.5 | 81.7 | 82.3 |
| Free chlorine (ppm) | 755 | 1217 | 140 |
| Epoxy equivalent (g/eq.) | 199 | 229 | 228 |
| Weight-average molecular | 3684 | 4061 | 5030 |
| weight (Mw) | | | |
| Molecular weight | 2.168 | 2.63 | 2.27 |
| distribution (Mw/Mn) | | | |

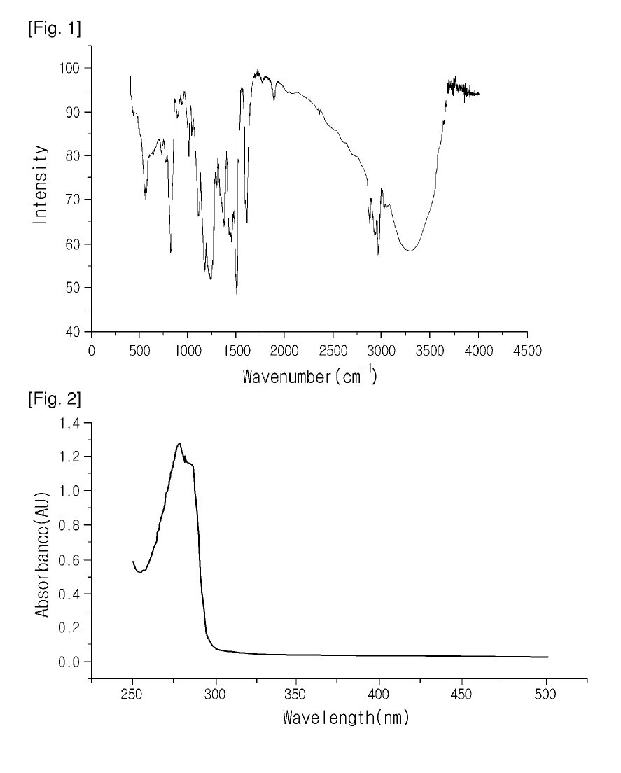

Meanwhile, FIG. 1 shows the results of FT-IR analysis for the epoxidized bisphenol-B novolac resin obtained in Example 6.

Also, FIG. 2 shows the results obtained by measuring the UV absorbance of the epoxidized bisphenol-B novolac resin obtained in Example 6. As can be seen from the results of FIG. 2, the epoxidized bisphenol-B novolac resin showed the maximum absorbance value (about 1.27) at 278 nm. Furthermore, the resin had no absorbance in the wavelength range above 300 nm. In this respect, it can be seen that the epoxidized bisphenol-B novolac resin is useful for forming a cured film using violet rays such as i-line radiation, because the absorbance coefficient at wavelengths above 300 nm is low.

### Examples 7 to 15

### Preparation of Epoxy Resin Compositions

According to the components and contents shown in Table 2 below, epoxy resin compositions were prepared. The amounts shown in Table 2 are given in “gram” (g) and based on solid contents.

TABLE 2

| | | Examples | | | | | | | | |
|---|---|---|---|---|---|---|---|---|---|---|
| | | 7 | 8 | 9 | 10 | 11 | 12 | 13 | 14 | 15 |
| Epoxy | A | 440 | — | — | 440 | — | — | 100 | — | — |
| resin | | | | | | | | | | |
| | B | — | 440 | — | — | 440 | — | — | 100 | — |
| | C | — | — | 440 | — | — | 440 | — | — | — |
| | D | | — | — | — | — | — | — | — | 440 |
| Curing | E | 254 | — | — | — | — | — | — | — | 254 |
| agent | | | | | | | | | | |
| | F | — | 254 | — | — | — | — | — | — | — |
| | G | — | — | 254 | — | — | — | — | — | — |
| | H | — | — | — | 240 | 240 | 240 | — | — | — |
| | I | — | — | — | — | — | — | 5 | 5 | — |
| Curing | J | 3.5 | 3.5 | 3.5 | 3.4 | 3.4 | 3.4 | — | — | 3.5 |
| accelerator | | | | | | | | | | |
| | K | — | — | — | — | — | — | 0.15 | 0.15 | — |

Note:
a: bisphenol-B novolac epoxy resin (epoxy equivalent: 199 g/eq.) of Example 4;
b: bisphenol-B novolac epoxy resin (epoxy equivalent: 229 g/eq.) of Example 5;
c: bisphenol-B novolac epoxy resin (epoxy equivalent: 228 g/eq.) of Example 6;
d: bisphenol-A novolac epoxy resin (epoxy equivalent: 221 g/eq.);
e: bisphenol-B novolac resin of Example 1;
f: bisphenol-B novolac resin of Example 2;
g: bisphenol-B novolac resin of Example 3;
h: bisphenol-A novolac resin;
i: dicyandiamide (10 wt % dispersion in DMF);
j: triphenylphosphine;
k: 2-methylimidazole (10 wt % dispersion in MCS).

The epoxy resin, a curing agent and a curing accelerator were blended with at least one solvent selected from dimethyl formamide (DMF), methyl cellosolve (MCS), methyl ethyl ketone (MEK) and acetone, thus preparing epoxy resin compositions having a solid content of 60-70%. Then, each of the epoxy resin compositions was impregnated into a glass fabric.

Then, each of the epoxy resin compositions was cured using a press in conditions of more than 180° C. and more than 20 kgf/cm², thus obtaining a prepreg containing the epoxy resin composition. Four prepregs obtained as described above were stacked on each other, and a 50-μm-thick copper foil was placed on both sides of the prepreg stack. The assembly was pressed at 170° C. at 10 kgf/cm² for 90 minutes. As a result, a 1.2-mm-thick, copper clad glass-epoxy laminate was obtained. The laminates were evaluated for heat resistance, drillability and adhesion to copper foil, and the evaluation results are shown in Table 3 below.

TABLE 3

| | Examples | | | | | | | | |
|---|---|---|---|---|---|---|---|---|---|
| | 7 | 8 | 9 | 10 | 11 | 12 | 13 | 14 | 15 |
| Tg (° C.) | 163 | 165 | 162 | 155 | 167 | 163 | 163 | 168 | 167 |
| Copper foil peel strength | 2.3 | 2.1 | 1.9 | 1.5 | 2.3 | 2.0 | 2.1 | 2.4 | 2.4 |
| Soldering heat resistance | Δ | ◯ | ◯ | Δ | ◯ | ◯ | Δ | ◯ | ◯ |
| Drillability | Good | Good | Good | Good | Good | Good | Good | Good | Good |

Tg: measured using a TA instrument's differential scanning calorimeter (DSC) by scanning at a rate of 10° C./min from room temperature (30° C.) to 300° C.
Soldering heat resistance: the laminate sample was treated in a pressure cooler at 120° C. at 2 atm for 8 hours, and then immersed in a soldering bath at 260° C. for 30 seconds. Then, the laminate sample was evaluated for the presence of blistering and peeling according to the following criteria: ◯ - no blistering and peeling; Δ - slight blistering and peeling; and X - severe blistering and peeling.
Drillability: evaluated by drilling the laminate sample under the following conditions and then examining the appearance of the drilled laminate sample with respect to resin contamination: Drill diameter: 0.3 mm; revolutions: 150,000 rpm; and supply: 1.0 m/min.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A phenol novolac resin which contains a repeating unit represented by the following formula 1 in the main chain and has a softening point between 50° C. and 150° C.:

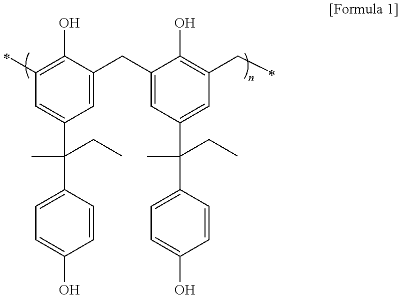

2. The phenol novolac resin of claim 1, which has a weight-average molecular weight of 500 to 5,000.

3. A phenol novolac epoxy resin which contains a repeating unit represented by the following formula 2 in the main chain:

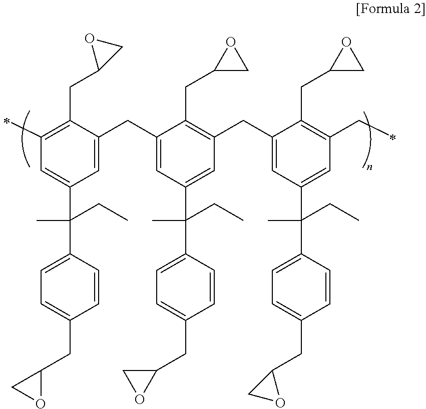

4. The phenol novolac epoxy rein of claim 3, which has an epoxy equivalent of 150 to 400 and a softening point between 50° C. and 150° C.

5. The phenol novolac epoxy resin of claim 3, which has a UV absorbance of not less than 1.1 at 278 nm.

6. An epoxy resin composition comprising:
an epoxy resin; and
a curing agent including a phenol novolac resin which contains a repeating unit represented by the following formula 1 in the main chain:

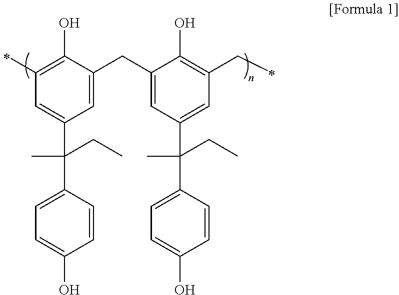

7. The epoxy resin composition of claim 6, wherein the epoxy resin is a phenol novolac epoxy resin which contains a repeating unit represented by the following formula 2 in the main chain:

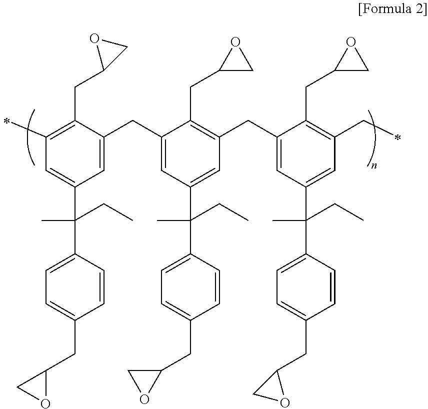

8. An epoxy resin composition comprising:
an epoxy resin including a phenol novolac epoxy resin which contains a repeating unit represented by the following formula 2 in the main chain; and
a curing agent: [chemical structure]
